(19) United States
(12) Patent Application Publication
(10) Pub. No.: US 2020/0225289 A1
(43) Pub. Date: Jul. 16, 2020

(54) METHOD AND APPARATUS FOR TESTING AN OPERATING METHOD

(71) Applicant: Robert Bosch GmbH, Stuttgart (DE)

(72) Inventors: Christel Sarfert, Korntal-Muenchingen (DE); Marcus Boege, Tuebingen (DE)

(21) Appl. No.: 16/739,241

(22) Filed: Jan. 10, 2020

(30) Foreign Application Priority Data
Jan. 16, 2019 (DE) 10 2019 200 454.7

(51) Int. Cl. G01R 31/367; G06F 30/20; H02J 7/00; H01M 10/42; H01M 10/48; G06F 111/10

(52) U.S. Cl. CPC G01R 31/367; G06F 30/20; G06F 2111/10; H01M 10/4285; H01M 10/48; H02J 7/0013

(57) ABSTRACT

A method and apparatus for testing an operating method, in particular for an electrical energy store, having the temporally successive method steps of:
wherein the operating method is defined in a first method step,
wherein a simulation of the operating method is created in a second method step,
wherein the operating method is applied to a test object in a third method step, wherein at least one state parameter of the test object is detected,
wherein the state parameter of the test object is evaluated and compared with the simulation in a fourth method step.

### BACKGROUND OF THE INVENTION

The present invention relates to a method and to an apparatus for testing an operating method.

Apparatuses for testing batteries are known from the prior art.

DE20 2008 007 663 U1 discloses a battery testing system having a battery tester.

### SUMMARY OF THE INVENTION

The essence of the invention with the method for testing an operating method, in particular for an electrical energy store, consists in the method having the following temporally successive method steps of:

wherein the operating method is defined in a first method step,

wherein a simulation of the operating method is created in a second method step,

wherein the operating method is applied to a test object in a third method step, wherein at least one state parameter of the test object is detected,

wherein the state parameter of the test object is evaluated and compared with the simulation in a fourth method step.

The background of the invention is that a simulation for an operating method is able to be checked on a real test object. Here, the parameters of the operating method are transmitted from a simulation unit to an apparatus for testing the operating method and the operating method is started on the apparatus.

Here, the simulation parameters, in particular mathematical models or a virtual test object, are advantageously able to be checked and improved.

Further advantageous embodiments of the present invention are the subject matter of the dependent claims.

In accordance with one advantageous configuration, operating instructions for the operating method are defined in the first method step. Said operating instructions are able to be executed both by the simulation unit and by the apparatus.

Furthermore, it is advantageous when the simulation is created by means of a virtual test object and/or by means of a mathematical model. Said virtual test object and/or mathematical model is able to be optimized by means of the method. As a result thereof, operating methods have to be tested by means of the method only in a random manner.

Here, it is advantageous when the virtual test object and/or the mathematical model is adjusted in a fifth method step. In this case, the result of the fourth method step is used and the virtual test object and/or the mathematical model is adjusted in such a way that the result of the simulation approximates the result of the measurements on the test object.

A new simulation is advantageously created by means of the adjusted virtual test object and/or the adjusted mathematical model in a sixth method step. As a result thereof, the adjusted virtual test object and/or the adjusted mathematical model is checked.

In accordance with one advantageous configuration, the operating method comprises a charging method and/or a discharging method and/or a balancing method and/or a load profile for an electrical energy store. As a result thereof, charging methods and/or discharging methods and/or balancing methods and/or load profiles for electrical energy stores are able to be simulated in a simple manner and the quality of the simulation is able to be tested.

The essence of the invention with the apparatus for testing an operating method, in particular by means of a method as described above or according to one of the claims related to the method consists in that the apparatus has a control unit, a measurement unit, a receptacle for at least one test object, in particular an electrical energy store, and a power supply unit, wherein the apparatus is configured to carry out the operating method on the test object.

The background of the invention is that a simulation for an operating method is able to be checked on a real test object. Here, the parameters of the operating method are transmitted from a simulation unit to the apparatus for testing the operating method and the operating method is started on the apparatus.

Here, the simulation parameters, in particular mathematical models or a virtual test object, are advantageously able to be checked and improved.

In accordance with one advantageous embodiment, the apparatus has a housing, in which the control unit, the measurement unit, the receptacle and the power supply unit are arranged. As a result thereof, the apparatus is able to be embodied so as to be compact and transportable. The greatest side length of the housing is advantageously smaller than 100 cm, in particular smaller than 70 cm, preferably smaller than 50 cm, and/or the apparatus is lighter than 10 kg, in particular lighter than 5 kg.

The test object is advantageously embodied as an electrical energy store. It is also advantageous when the electrical energy store is likewise able to be arranged in the housing, in particular is able to be removed therefrom.

Furthermore, it is advantageous when the receptacle is suitable for receiving a plurality of test objects, wherein the test objects are arranged so as to be connected in series or to be connected in parallel. As a result thereof, the apparatus is suitable for testing interactions between the different test objects.

In accordance with one advantageous configuration, the measurement unit has at least one sensor, in particular a voltage sensor and/or a current sensor and/or a temperature sensor, and/or a configurable input,

wherein the measurement unit is connected to the control unit in a data-carrying manner,

wherein the measurement unit is able to be connected to the respective test object. The individual test objects are therefore each able to be evaluated individually. The measurement data of the measurement unit are able to be transmitted to the control unit and able to be evaluated by same.

The control unit is advantageously configured to control the power supply unit,

wherein the power supply unit is able to be electrically conductively connected to the respective test object. As a result thereof, the power supply unit is configured to implement the operating method on the test object.

Furthermore, it is advantageous when the control unit is able to be connected in a data-carrying manner to a simulation unit. As a result thereof, operating parameters are able to be transmitted from the simulation unit to the control unit. Measurement results and evaluations are able to be transmitted from the control unit to the simulation unit.

The above configurations and developments can be combined with one another arbitrarily, as far as appropriate. Further possible configurations, developments and implementations of the invention also comprise combinations of features of the invention described above or below with respect to the exemplary embodiments that are not explicitly cited. In particular, a person skilled in the art will also add individual aspects as improvements or additions to the respective basic form of the present invention.

### BRIEF DESCRIPTION OF THE DRAWINGS

The section that follows explains the invention on the basis of exemplary embodiments, from which further inventive features can arise, the scope of the invention not being restricted to said features, however. The exemplary embodiments are depicted in the drawings,

in which:

FIG. 1 shows a schematic illustration of an apparatus 1 according to the invention for testing an operating method and

FIG. 2 shows a flow diagram of a method 100 according to the invention for testing an operating method.

### DETAILED DESCRIPTION

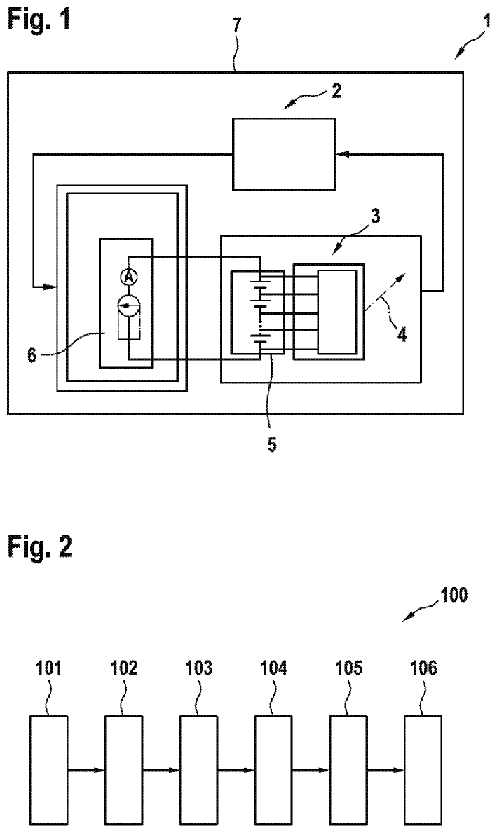

The apparatus 1 illustrated in FIG. 1 for testing an operating method has a control unit 2, a measurement unit 3, a receptacle 5 for at least one test object, in particular an electrical energy store, a power supply unit 6 and a housing 7.

The control unit 2, the measurement unit 3, the receptacle 5 and the power supply unit 6 are arranged in the housing 7.

The receptacle 5 is preferably suitable for receiving a plurality of similar test objects. The respective test object is held here by the receptacle 5 and electrically conductively connected to the power supply unit 6 and to the measurement unit 3.

The test object is preferably embodied as an electrical energy store. A plurality of electrical energy stores are able to be received in the receptacle 5 in a manner connected in series and/or connected in parallel.

The control unit 2 is connected in a data-carrying manner to the power supply unit 6 and to the measurement unit 3.

The control unit 2 is configured to control the power supply unit 6, in particular to control an output voltage and/or an output current of the power supply unit 6. To this end, the power supply unit 6 has a voltage sensor and/or a current sensor. Furthermore, the power supply unit 6 has an overvoltage protection system and an overtemperature protection system. The power supply unit 6 has a display means for displaying a power supply unit status.

The control unit 2 is configured to receive and to evaluate a measurement signal of the measurement unit 3. The measurement unit 3 has at least one voltage sensor and/or a current sensor and/or a temperature sensor. Furthermore, the measurement unit 3 has an, in particular configurable, input 4, which is able to be connected to a further sensor. In this case, the further sensor is able to be exchanged. The measurement unit 3 has a display means for displaying a measurement unit status. The measurement unit has a storage means for storing measurement data and/or fault status data.

The control unit 2 is able to be connected in a data-carrying manner to an external simulation unit, in particular in a wired or wireless manner. The simulation unit is configured to simulate the operating method by means of mathematical models. Said mathematical models describe a virtual test object. The operating method is able to be transmitted from the simulation unit to the control unit 2, in particular in the form of operating instructions.

The apparatus 1 is configured to carry out the operating method independently of the simulation unit. Here, the data-carrying connection between the control unit 2 and the simulation unit is able to be disconnected, in particular after the transmission of the operating method to the control unit 2.

The apparatus 1 is configured to carry out the operating method on the test object and therefore to test the operating method. Here, measurement data of the test object are detected during the operating method and are preferably at least partly evaluated.

The control unit 2 is configured to transmit results of the operating method tested on the test object to the simulation unit. The simulation unit is configured to evaluate the results of the operating method tested on the test object and to compare them with a simulation result.

The operating method comprises, for example, a charging method and/or a discharging method and/or a balancing method and/or a load profile for an electrical energy store.

FIG. 2 illustrates the method 100 according to the invention for testing an operating method as a flow diagram. The method 100 has the following method steps:

The operating method is defined in a first method step 101. To this end, operating instructions for the operating method are defined.

A simulation of the operating method is created, in particular by means of a virtual test object and/or by means of a mathematical model, in a second method step 102.

The operating method is applied to a test object in a third method step 103. In this case, at least one state parameter of the test object is detected.

The state parameter of the test object is evaluated and compared with the simulation in a fourth method step 104.

The virtual test object and/or the mathematical model is adjusted in a fifth method step 105.

A new simulation is created by means of the adjusted virtual test object and/or the adjusted mathematical model in a sixth method step 106.

An electrical energy store is understood here to be a rechargeable energy store, in particular having an electrochemical energy storage cell and/or an energy storage module having at least one electrochemical energy storage cell and/or an energy storage pack having at least one energy storage module. The energy storage cell is able to be embodied as a lithium-based battery cell, in particular a lithium ion battery cell. As an alternative, the energy storage cell is embodied as a lithium polymer battery cell or nickel metal hydride battery cell or lead acid battery cell or lithium air battery cell or lithium sulfur battery cell.

1. A method (100) for testing an operating method for an electrical energy store having the temporally successive method steps of:
wherein the operating method is defined in a first method step (101),
wherein a simulation of the operating method is created in a second method step (102),
wherein the operating method is applied to a test object in a third method step (103), wherein at least one state parameter of the test object is detected,
wherein the state parameter of the test object is evaluated and compared with the simulation in a fourth method step (104).

2. The method (100) according to claim 1,
characterized in that
operating instructions for the operating method are defined in the first method step (101).

3. The method (100) according to claim 1,
characterized in that
the simulation is created by means of a virtual test object and/or by means of a mathematical model.

4. Method (100) according to claim 3,
characterized in that
the virtual test object and/or the mathematical model is adjusted in a fifth method step (105).

5. The method (100) according to claim 4,
characterized in that
a new simulation is created using the adjusted virtual test object and/or the adjusted mathematical model in a sixth method step (106).

6. The method (100) according to claim 1,
characterized in that
the operating method comprises at least one of a charging method, a discharging method, a balancing method, and a load profile for an electrical energy store.

7. An apparatus (1) for testing an operating method, by a method (100) according to claim 1,
characterized in that
the apparatus (1) has a control unit (2), a measurement unit (3), a receptacle (5) for at least one test object, in particular an electrical energy store, and a power supply unit (6),
wherein the apparatus (1) is configured to carry out the operating method on the test object.

8. The apparatus (1) according to claim 7,
characterized in that
the apparatus (1) has a housing (7), in which the control unit (2), the measurement unit (3), the receptacle (5) and the power supply unit (6) are arranged.

9. The apparatus (1) according to claim 7,
characterized in that
the test object is an electrical energy store.

10. The apparatus (1) according to claim 7,
characterized in that
the receptacle (5) is suitable for receiving a plurality of test objects, wherein the test objects are arranged so as to be connected in series.

11. The apparatus (1) according to claim 7,
characterized in that
the receptacle (5) is suitable for receiving a plurality of test objects, wherein the test objects are arranged so as to be connected in parallel.

12. The apparatus (1) according to claim 7,
characterized in that
the measurement unit (3) has at least one sensor, comprising one or more of a voltage sensor, a current sensor, a temperature sensor, and a configurable input,
wherein the measurement unit (3) is connected in a data-carrying manner to the control unit (2),
wherein the measurement unit (3) is able to be connected to the respective test object.

12. The apparatus (1) according to claim 7,
characterized in that
the control unit (2) is configured to control the power supply unit (6),
wherein the power supply unit (6) is able to be electrically conductively connected to the respective test object.

13. The apparatus (1) according to claim 7,
characterized in that
the control unit (2) is able to be connected in a data-carrying manner to a simulation unit.
